(19) United States
(12) Patent Application Publication
(10) Pub. No.: US 2017/0093173 A1
(43) Pub. Date: Mar. 30, 2017

(54) FRONT END CHARGER BYPASS SWITCH WITH LINEAR REGULATION FUNCTION AND PATH FOR REVERSE BOOST

(71) Applicants: Han Kung Chua, Bayan Lepas (MY); Alexander B. Uan-Zo-Li, Hillsboro, OR (US)

(72) Inventors: Han Kung Chua, Bayan Lepas (MY); Alexander B. Uan-Zo-Li, Hillsboro, OR (US)

(21) Appl. No.: 14/864,384

(22) Filed: Sep. 24, 2015

(51) Int. Cl. H02J 7/00

(52) U.S. Cl. CPC H02J 7/007; H02J 7/0052; H02J 7/0068

(57) ABSTRACT

Methods, apparatuses, and systems may provide for regulating the system voltage in a mobile device by utilizing a bypass switch as a linear control circuit. A second switch is connected an output of a first switch and to a voltage control circuit. The linear control circuit detects a system voltage and compares the detected system voltage to a reference voltage. The linear control circuit will fully turn on the second switch when the system voltage is below the voltage threshold set by the reference voltage. However, when the system voltage exceeds the set voltage threshold, the second switch will automatically clamp the system voltage to remain at the voltage that is set by reference voltage.

### BACKGROUND

Technical Field

Embodiments generally relate to regulating the system voltage in a mobile device. More particularly, embodiments relate to regulating the system voltage in a mobile device by utilizing a bypass switch as a linear regulator.

Discussion

Mobile devices, for example, notebook computers, convertible tablets, phablets, and so forth may generally be powered by an internal battery when the device is not connected to an external power source such as an alternating current (AC) adapter or a docking station. When the devices are used in a docked mode, the devices consume a large amount of power. The narrow voltage direct current (NVDC) charger scheme is a conventional way to down convert the external power source to a lower voltage. The low voltage output by the NVDC charger may be used to charge the internal battery. When docked, the power is provided from the docking station through a Type-C port.

With the related art NVDC battery charger approach, all of the power from the adapter to the system must come through the charger. This means that the NVDC charger must be designed for the full system power in addition to the battery charging. This approach works well in some instances where it is not assumed that the system will consume a lot of power when charging. However, this approach may not work well in other instances, for example, when devices are operating in a laptop-like mode, in which case, the power consumption is very high.

### BRIEF DESCRIPTION OF THE DRAWINGS

The various advantages of the embodiments will become apparent to one skilled in the art by reading the following specification and appended claims, and by referencing the following drawings, in which:

FIG. 1 is an illustration of a charger system according to an embodiment;

FIG. 2 is an illustration of a control circuit of the charger system according to an embodiment;

FIG. 3 shows a flowchart of an example of a method of operating the charger system to an embodiment.

### DETAILED DESCRIPTION OF EXEMPLARY EMBODIMENTS

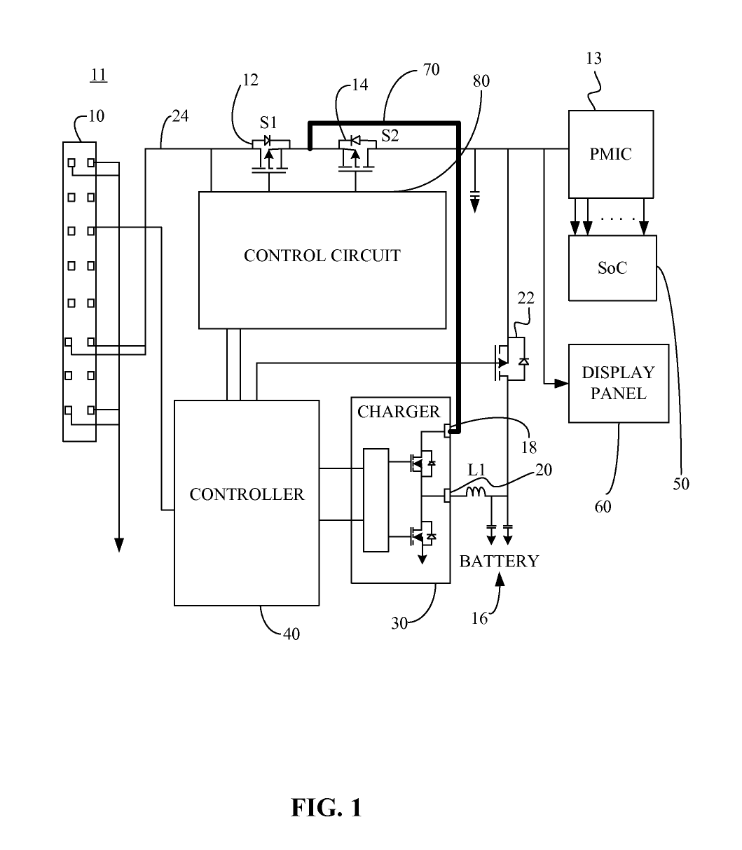

FIG. 1 is a view illustrating a charger system according to an exemplary embodiment. The charger system 1 includes a power supply port 10, a first switch 12, a second switch 14, a battery 16, a first charge port 18, a second charge port 20, a charger 30, a controller 40, a power management integrated circuit (PMIC) 13, a System on a Chip (SoC) or processor 50, and a display panel 60.

According to the embodiment, a mobile device, for example, a convertible tablet, a phablet, and so forth may operate as a phone or phablet when undocked, but may operate as a laptop when docked. When the device is in a docked state, a greater power consumption level is attained.

Referring now to FIG. 1, there is illustrated a schematic diagram of a charger system according to an embodiment. A power supply port 10 is connected to a battery 16 via a controller 40 and a charger 30. The power supply port 10 may be a Type-C port, but is not limited thereto. The controller 40 may be a universal serial bus (USB) power delivery (PD) controller or a Type-C port controller, but is not limited thereto.

The first switch 12 and second switch 14 may act as a bypass switches. If there is a fault on VBUS 24, switch 12 will be turned off to protect the battery from draining its power through switch 22. If there is a fault on the VSYS or the PMIC 13, switch 14 will be turned off to protect VBUS 24 from draining its power to the faulty point. During normal operations, both switch 12 and switch 14 are turned on. The switches 12 and 14 may be field effect transistor (FET) switches, but are not limited thereto.

The external power source may include a relatively high voltage AC adapter or a relatively high voltage docking station.

The power from the input power source is fed from the power supply port 10 over VBUS 24. The VBUS is connected to the first switch 12. The first switch 12 is connected to the control circuit 80, and to the second switch 14. The second switch 14 is also connected to the control circuit 80.

When the power is sensed on the VBUS 24, switch 12 and switch 14 are turned on, and switch 22 is turned off. Power is then supplied to power the system or the power management integrated circuit (PMIC). Power is also supplied to the charger 30, which then charges the battery 16 via a charger node 20. The battery may then be used as the power supply source for the device when VBUS is not operative.

If a USB device is connected to the power supply port 10, the charger 30 will act as a 5V reverse boost and supply 5V to the connected USB device via path 70 and switch 12.

The voltage bus (VBUS) 24, which receives power from the power supply 10, may have a specified voltage level of 5.5V, which could be above the voltage rating of most tablet power management integrated circuit (PMIC) field effect transistors (FETs). In order to protect the PMIC, the control circuit 80 may control switch 14 to act as a linear regulator and clamp or regulate a system voltage(VSYS) to a specified level, for example, 5.25V.

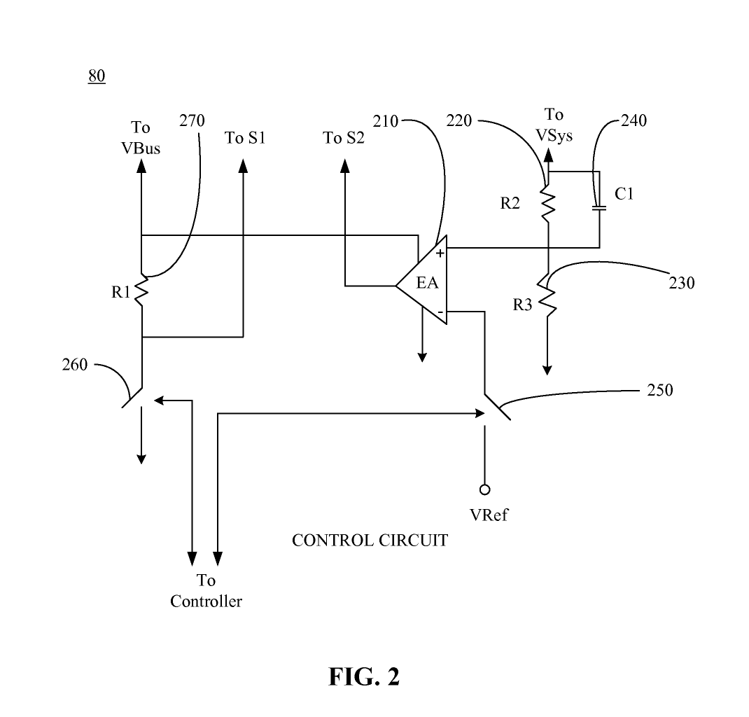

FIG. 2 is a detailed illustration of the control circuit 80 as shown in FIG. 1. An error amplifier 210 of the control circuit 80 is operable to compare a system voltage (VSYS) with a reference voltage (VREF). A positive pole of the error amplifier 210 is connected to a node between a first control circuit resistor 220 and a second control circuit resistor 230, and a negative node of the error amplifier is connected to a second control circuit switch 250.

A first control circuit switch 260 controls the first switch 12 and the second control circuit switch 250 controls the linear control circuit. When the USB device is plugged into the power supply port 10, (which may be a Type-C port), the charger 30 operates as a reverse boost and generates and delivers 5V to the power to the power supply port 10. At this time, the switches 12 (as shown in FIG. 1), 250, and 260 are turned on, and switch 14 (as shown in FIG. 1) is turned off.

When the device is connected to the docking station and is receiving power from the power supply port 10, first switch S1 12 and second switch S2 14 will be turned on. In this case, when paired with the control circuit 80, the second switch S2 14 may act as a linear regulator—unlike related art systems. The circuitry of the control circuit 80 will detect or sense the VSYS voltage through control circuit resistor R2 220 and control circuit resistor R3 230, and compare the detected VSYS to the VREF with the error amplifier 210. The linear control circuit 80 will fully turn on the second switch S2 14 when VSYS voltage is below the voltage threshold set by the VREF, control circuit resistor R2 220, and control circuit resistor R3 230. However, when VSYS voltage exceeds the set voltage threshold, the second switch S2 14 will automatically act as a linear regulator and regulate VSYS to remain at the voltage that is set by VREF, control circuit resistor R2, and control circuit resistor R3. For example, VREF, control circuit resistor R2 220, and control circuit resistor R3 230 can be set so that VSYS will not exceed 5.2V. However, the threshold level of the VSYS is not limited to 5.2V. The threshold level may be set to a voltage rating that is suitable for any tablet PMIC FET.

According to another exemplary embodiment, a charge port 18 connects the charger 30 to a node of the VBUS 24 between the first switch 12 and the second switch 14 via a connection 70. The charger 30 generates and delivers a reverse voltage to the first switch 12 via the connection line 70. Power is supplied to the power supply port 10 from the charger 30 when a USB device is plugged onto the port.

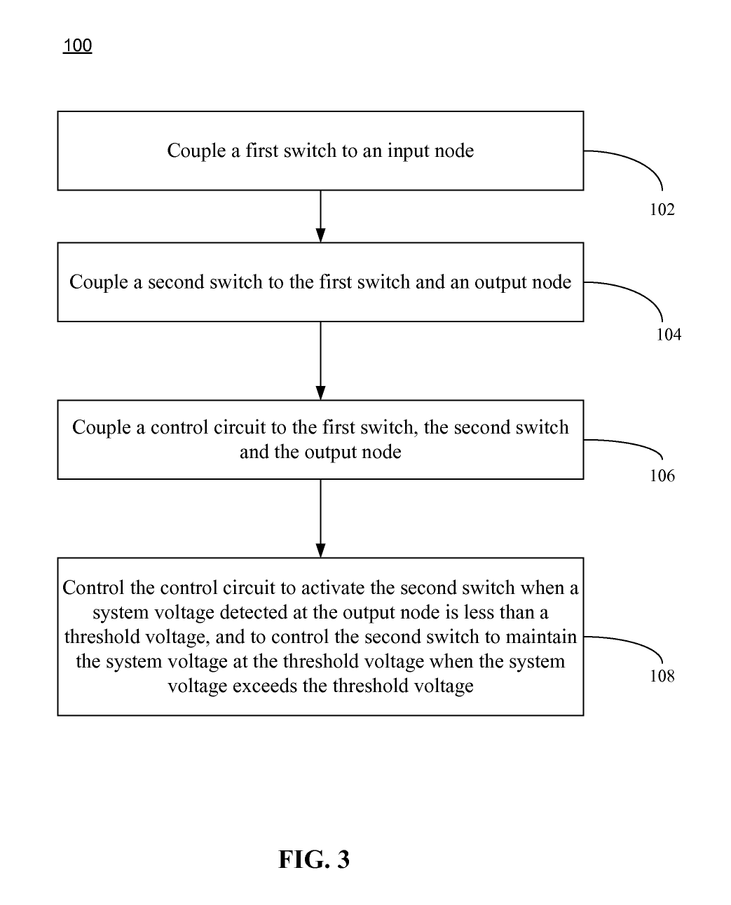

FIG. 3 shows a method 100 for regulating the system voltage in a mobile device. Illustrated processing block S1 provides coupling a first switch to an input node. The input node receives power from a power supply source. In block S2, a second switch is connected to an output of the first switch and is also connected to an output node. Additionally, block S3 may involve coupling a control circuit to the first switch, the second switch, and the output node. Illustrated block S4 controls the control circuit to activate the second switch when a system voltage detected at the output node is less than a threshold voltage, and controls the second switch to maintain the system voltage at the threshold voltage when the system voltage exceeds the threshold voltage.

### Additional Notes and Examples

Example 1 may include an apparatus comprising a first switch coupled to an input node; a second switch coupled to the first switch and to an output node; a power supply port connected to the input node; a charger having a first charge port, and a second charge port to couple the charger to the first switch and the second switch; and a control circuit coupled to the first switch, the second switch, and the output node, the control circuit to activate the second switch when a system voltage detected at the output node is less than a threshold voltage, and to control the second switch to maintain the system voltage at the threshold voltage when the system voltage exceeds the threshold voltage, wherein the control circuit includes a resistance divider and an error amplifier.

Example 2 may include the apparatus of Example 1, wherein the control circuit further includes a first control circuit switch, a second control circuit switch and a control circuit resistor.

Example 3 may include the apparatus of Example 1, wherein the charger is to generate and deliver a reverse voltage to the first switch.

Example 4 may include the apparatus of Example 1, wherein the charger is to generate and deliver a reverse voltage to the first switch.

Example 5 may include a system comprising a display panel; a power management integrated circuit (PMIC); a processor; a first switch coupled to an input node; a second switch coupled to the first switch and to an output node; and a control circuit coupled to the first switch, the second switch, and the output node, the control circuit to activate the second switch when a system voltage detected at the output node is less than a threshold voltage, and to control the second switch to maintain the system voltage at the threshold voltage when the system voltage exceeds the threshold voltage.

Example 6 may include the system of Example 5, wherein the control circuit includes a resistance divider and an error amplifier.

Example 7 may include the system of Example 6, wherein the control circuit further includes a first control circuit switch, a second control circuit switch and a control circuit resistor.

Example 8 may include the system of Example 5, further including a charger having a first charge port, and a second charge port to couple the charger to the first switch and the second switch.

Example 9 may include the system of Example 8, wherein the charger is to generate and deliver a reverse voltage to the first switch.

Example 10 may include the system of Example 5, wherein a power supply port is connected to the input node.

Example 11 may include the system of Example 5, further comprising a power delivery (PD) controller coupled to the power supply port and the control circuit.

Example 12 may include an apparatus comprising a first switch coupled to an input node; a second switch coupled to the first switch and to an output node; and a control circuit coupled to the first switch, the second switch, and the output node, the control circuit to activate the second switch when a system voltage detected at the output node is less than a threshold voltage, and to control the second switch to maintain the system voltage at the threshold voltage when the system voltage exceeds the threshold voltage.

Example 13 may include the apparatus of Example 12, wherein the control circuit includes a resistance divider and an error amplifier.

Example 14 may include the apparatus of Example 13, wherein the control circuit further includes a first control circuit switch, a second control circuit switch and a control circuit resistor.

Example 15 may include the apparatus of Example 12, further including a charger having a first charge port, and a second charge port to couple the charger to the first switch and the second switch.

Example 16 may include the apparatus of Example 15, wherein the charger is to generate and deliver a reverse voltage to the first switch.

Example 17 may include the apparatus of Example 12, wherein a power supply port is connected to the input node.

Example 18 may include the apparatus of Example 12, further comprising a power delivery (PD) controller coupled to the power supply port and the control circuit.

Example 19 may include a method of regulating voltage comprising coupling a first switch to an input node; coupling a second switch to the first switch and to an output node; coupling a control circuit to the first switch, the second switch, and to the output node, and controlling the control circuit to activate the second switch when a system voltage detected at the output node is less than a threshold voltage, and to control the second switch to maintain the system voltage at the threshold voltage when the system voltage exceeds the threshold voltage.

Example 20 may include the method of Example 19, wherein the control circuit includes a resistance divider to receive the system voltage, and an error amplifier to compare the system voltage to a reference voltage.

Example 21 may include the method of Example 20, wherein the control circuit further includes a first control circuit switch to control the first switch, a second control circuit switch and a control circuit resistor.

Example 22 may include the method of Example 19 wherein a charger includes a first charge port to couple the charger to a battery, and a second charge port to couple the charger to the first switch and the second switch to provide a path from the charger to the first switch.

Example 23 may include the method of Example 22, wherein the charger is to generate and deliver a reverse voltage to the first switch.

Example 24 may include the method of Example 19, wherein a power supply port is connected to the input node to provide power to the apparatus.

Example 25 may include the method of Example 19, further comprising a power delivery (PD) controller coupled to the power supply port and the control circuit to control the first switch and the second switch.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

Those skilled in the art will appreciate from the foregoing description that the broad techniques of the embodiments can be implemented in a variety of forms. Therefore, while the embodiments of this have been described in connection with particular examples thereof, the true scope of the embodiments should not be so limited since other modifications will become apparent to the skilled practitioner upon a study of the drawings, specification, and following claims.

We claim:

1. An apparatus comprising:
a first switch coupled to an input node;
a second switch coupled to the first switch and to an output node;
a power supply port connected to the input node;
a charger having a first charge port, and a second charge port to couple the charger to the first switch and the second switch; and
a control circuit coupled to the first switch, the second switch, and the output node, the control circuit to activate the second switch when a system voltage detected at the output node is less than a threshold voltage, and to control the second switch to maintain the system voltage at the threshold voltage when the system voltage exceeds the threshold voltage,
wherein the control circuit includes a resistance divider and an error amplifier.

2. The apparatus of claim 1, wherein the control circuit further includes a first control circuit switch, a second control circuit switch and a control circuit resistor.

3. The apparatus of claim 1, wherein the charger is to generate and deliver a reverse voltage to the first switch.

4. The apparatus of claim 1, further comprising a power delivery (PD) controller coupled to the power supply port and the control circuit.

5. A system comprising:
a display panel;
a power management integrated circuit (PMIC);
a processor;
a first switch coupled to an input node;
a second switch coupled to the first switch and to an output node; and
a control circuit coupled to the first switch, the second switch, and the output node, the control circuit to activate the second switch when a system voltage detected at the output node is less than a threshold voltage, and to control the second switch to maintain the system voltage at the threshold voltage when the system voltage exceeds the threshold voltage.

6. The system of claim 5, wherein the control circuit includes a resistance divider and an error amplifier.

7. The system of claim 6, wherein the control circuit further includes a first control circuit switch, a second control circuit switch and a control circuit resistor.

8. The system of claim 5, further including a charger having a first charge port, and a second charge port to couple the charger to the first switch and the second switch.

9. The system of claim 8, wherein the charger is to generate and deliver a reverse voltage to the first switch.

10. The system of claim 5, wherein a power supply port is connected to the input node.

11. The system of claim 5, further comprising a power delivery (PD) controller coupled to the power supply port and the control circuit.

12. An apparatus comprising:
a first switch coupled to an input node;
a second switch coupled to the first switch and to an output node; and
a control circuit coupled to the first switch, the second switch, and the output node, the control circuit to activate the second switch when a system voltage detected at the output node is less than a threshold voltage, and to control the second switch to maintain the system voltage at the threshold voltage when the system voltage exceeds the threshold voltage.

13. The apparatus of claim 12, wherein the control circuit includes a resistance divider and an error amplifier.

14. The apparatus of claim 13, wherein the control circuit further includes a first control circuit switch, a second control circuit switch and a control circuit resistor.

15. The apparatus of claim 12, further including a charger having a first charge port, and a second charge port to couple the charger to the first switch and the second switch.

16. The apparatus of claim 15, wherein the charger is to generate and deliver a reverse voltage to the first switch.

17. The apparatus of claim 12, wherein a power supply port is connected to the input node.

18. The apparatus of claim 12, further comprising a power delivery (PD) controller coupled to the power supply port and the control circuit.

19. A method of regulating voltage comprising:
coupling a first switch to an input node;
coupling a second switch to the first switch and to an output node;
coupling a control circuit to the first switch, the second switch, and to the output node, and
controlling the control circuit to activate the second switch when a system voltage detected at the output node is less than a threshold voltage, and to control the second switch to maintain the system voltage at the threshold voltage when the system voltage exceeds the threshold voltage.

20. The method of claim 19, wherein the control circuit includes a resistance divider to receive the system voltage, and an error amplifier to compare the system voltage to a reference voltage.

21. The method of claim 20, wherein the control circuit further includes a first control circuit switch to control the first switch, a second control circuit switch and a control circuit resistor.

22. The method of claim 19 wherein a charger includes a first charge port to couple the charger to a battery, and a second charge port to couple the charger to the first switch and the second switch to provide a path from the charger to the first switch.

23. The method of claim 22, wherein the charger is to generate and deliver a reverse voltage to the first switch.

24. The method of claim 19, wherein a power supply port is connected to the input node to provide power to the apparatus.

25. The method of claim 19, further comprising a power delivery (PD) controller coupled to the power supply port and the control circuit to control the first switch and the second switch.
